(19) United States
(12) Patent Application Publication
(10) Pub. No.: US 2025/0346735 A1
(43) Pub. Date: Nov. 13, 2025

(54) POLYSILOXANE COMPOSITION

(71) Applicant: Merck Patent GMBH, Darmstadt (DE)

(72) Inventor: Kensuke Aida, Fukuroi Shizuoka (JP)

(21) Appl. No.: 19/219,796

(22) Filed: May 27, 2025

Related U.S. Application Data
(63) Continuation of application No. PCT/EP2023/082938, filed on Nov. 24, 2023.

(30) Foreign Application Priority Data
Nov. 28, 2022 (JP) 2022-189361

(51) Int. Cl. C08K 5/3445; C08K 5/092; C08K 5/19

(52) U.S. Cl. CPC C08K 5/3445; C08K 5/092; C08K 5/19

(57) ABSTRACT

A polysiloxane composition includes: (I) a polysiloxane, (II) an ionic liquid, (III) an acid, and (IV) a solvent, in which the mixing ratio ((II)/(III)) of the ionic liquid (II) to the acid (III) is 0.001 to 0.09 at an equivalent ratio.

### CROSS-REFERENCE TO RELATED APPLICATIONS

This application is a Continuation under 35 USC § 111(a) of International Patent Application No. PCT/EP2023/082983 filed Nov. 24, 2023, which claims priority to the JP Application no. 2022-189361 filed Nov. 28, 2022. The entire contents of these applications are incorporated herein by reference in their entirety.

### BACKGROUND OF THE INVENTION

### Field of the Invention

The present invention relates to a polysiloxane composition. Further, the present invention relates to a method for manufacturing a film using the same, a film using the same, and a method for manufacturing an electronic device comprising the film.

### Background Art

Polysiloxane is known to have resistance to elevated temperature. When a cured film is formed from a composition containing a polysiloxane, the coating film is heated at an elevated temperature to rapidly proceed with a condensation reaction of silanol groups in the polysiloxane and a reaction of a polymer having an unsaturated bond to cure the film. If unreacted reactive groups remain, they may react with the chemicals to be used in the device manufacturing process. Due to the influence on other materials in the substrate and from the device conditions, the development of a composition containing polysiloxane capable of being cured at a lower temperature has been desired.

For the purpose of curing an epoxy resin at a low temperature, the combination of an epoxy resin, an anionic polymerizable curing agent and an ionic liquid has been proposed as disclosed in JP 2019-14781 A, and in a comparative example where no anionic polymerizable curing agent is contained, any curing is not caused.

It is desired to reduce the parasitic capacitance and increase the speed of signal propagation by using a low dielectric constant insulating material. As a method for reducing a dielectric constant in a film, there is a method of incorporating very small and uniform dispersion holes in the film. For example, it has been proposed that a coating film is formed with a solution containing a polysiloxane, and then heat treatment is performed to decompose and volatilize organic components, thereby forming a large number of pores after the volatilized components as disclosed in JP 2004-292638 A. The film thus formed may have a low mechanical strength.

### SUMMARY OF THE INVENTION

### Problems to be Solved by the Invention

The present inventors considered that there are one or more problems still in need of improvements. Examples of such problems are as follows.

Heating at a high temperature is required for curing; it is desirable for the storage stability to be further improved; it is also desirable for the dielectric constant of the cured film to be further lowered; the mechanical strength of the cured film could be improved; and the electrical characteristics could also be further improved.

### Means for Solving the Problems

A polysiloxane composition according to the present invention comprises:
(I) a polysiloxane,
(II) an ionic liquid,
(III) an acid, and
(IV) a solvent,
in which the mixing ratio ((II)/(III)) of the ionic liquid (II) to the acid (III) is 0.001 to 0.09 at an equivalent ratio.

A method for manufacturing a cured film according to the present invention includes applying the above-mentioned composition above a substrate to form a film, and subjecting the film to heating, light irradiation, or a combination thereof.

A cured film according to the present invention is manufactured or capable of being manufactured by the above-mentioned method.

An electronic device according to the present invention includes the above-mentioned cured film.

A method for manufacturing an electronic device according to the present invention includes the above-mentioned method for manufacturing a cured film.

### Effects of the Invention

In the polysiloxane composition according to the present invention, it is possible to expect one or more of the following effects.

The composition can be cured at a temperature lower than a temperature range adopted for a general thermosetting composition; the storage stability is sufficient; a cured film having a suppressed dielectric constant can be formed; a cured film having a sufficient mechanical strength can be formed; and a cured film sufficient in electrical characteristics can be formed.

### DETAILED DESCRIPTION OF THE INVENTION

### Definitions

Unless otherwise specified in the present specification, the definitions and examples described in this paragraph are followed.

The singular form includes the plural form and “one” or “that” means “at least one”. An element of a concept can be expressed by a plurality of species, and when the amount (for example, mass % or mol %) is described, it means sum of the plurality of species.

“And/or” includes a combination of all elements and also includes single use of the element.

When a numerical range is indicated using “to” or “-”, it includes both endpoints and units thereof are common. For example, 5 to 25 mol % means 5 mol % or more and 25 mol % or less.

The descriptions such as “C_{x-y}”, “Cₓ-C_{y}” and “Cₓ” mean the number of carbons in a molecule or substituent. For example, C₁₋₆ alkyl means an alkyl chain having 1 or more and 6 or less carbons (methyl, ethyl, propyl, butyl, pentyl, hexyl etc.).

When a polymer has a plurality of types of repeating units, these repeating units copolymerize. Copolymerization may be any of alternating copolymerization, random copolymerization, block copolymerization, graft copolymerization, or a mixture thereof. When a polymer or resin is represented by a structural formula, n, m or the like that is attached next to parentheses indicate the number of repetitions.

Celsius is used as the temperature unit. For example, 20 degrees means 20 degrees Celsius.

The additive refers to a compound itself having a function thereof (for example, in the case of a base generator, a compound itself that generates a base). An embodiment in which the compound is dissolved or dispersed in a solvent and added to a composition is also possible. As one embodiment of the present invention, it is preferable that such a solvent is contained in the composition according to the present invention as the solvent (IV) or another component.

Hereinafter, embodiments of the present invention are described in detail.

### Polysiloxane Composition

The polysiloxane composition according to the present invention (hereinafter sometimes simply referred to as the composition) comprises (I) a polysiloxane, (II) an ionic liquid, (III) an acid, and (IV) a solvent.

The mixing ratio ((II)/(III)) of the ionic liquid (II) to the acid (II) is 0.001 to 0.09 at an equivalent ratio.

Hereinafter, each component contained in the composition according to the present invention is described in detail.

### (I) Polysiloxane

The structure of the polysiloxane used in the present invention is not particularly limited, and any polysiloxane can be selected depending on the purpose. Depending on the number of oxygen atoms bonded to a silicon atom, the skeleton structure of a polysiloxane can be classified into a silicone skeleton (the number of oxygen atoms bonded to a silicon atom is 2), a silsesquioxane skeleton (the number of oxygen atoms bonded to a silicon atom is 3) and a silica skeleton (the number of oxygen atoms bonded to a silicon atom is 4). In the present invention, any of these may be used. The polysiloxane molecule may contain a plurality of combinations of any of these skeletal structures.

Preferably, the polysiloxane used in the present invention comprises a repeating unit represented by the following formula (Ia) and a repeating unit represented by the following formula (Ib).

The formula (Ia) is as follows:

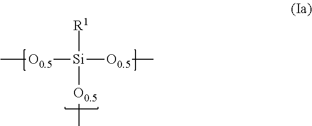

wherein,
R¹ is hydrogen, a mono- to trivalent, linear, branched or cyclic, saturated or unsaturated, C₁₋₃₀ aliphatic hydrocarbon group, or a mono- to trivalent, C₆₋₃₀ aromatic hydrocarbon group, preferably hydrogen, linear, branched or cyclic, C₁₋₆ alkyl, or C₆₋₁₀ aryl, more preferably hydrogen, methyl, ethyl or phenyl, further preferably methyl.

The aliphatic hydrocarbon group and the aromatic hydrocarbon group are each unsubstituted or substituted with fluorine, hydroxy or C₁₋₈ alkoxy,
in the aliphatic hydrocarbon group and the aromatic hydrocarbon group, methylene is not replaced, or one or more methylene are replaced with oxy, imide or carbonyl, provided that R¹ is neither hydroxy nor alkoxy, and
when R¹ is divalent or trivalent, R¹ connects each Si contained in a plurality of repeating units.

In the formula (Ia), when R¹ is a monovalent group, examples of R¹ include, in addition to hydrogen, (i) alkyl such as methyl, ethyl, propyl, butyl, pentyl, hexyl, heptyl, octyl and decyl, (ii) aryl such as phenyl, tolyl and benzyl, (iii) fluoroalkyl such as trifluoromethyl, 2,2,2-trifluoroethyl and 3,3,3-trifluoropropyl, (iv) fluoroaryl, (v) cycloalkyl such as cyclohexyl, (vi) nitrogen-containing groups having an amino or imide structure such as isocyanates and aminos, and (vii) oxygen-containing groups having an epoxy structure such as glycidyl, or an acryloyl or methacryloyl structure. Preferred are methyl, ethyl, propyl, butyl, pentyl, hexyl, phenyl, tolyl, glycidyl and isocyanate. As the fluoroalkyl, perfluoroalkyl, particularly trifluoromethyl and pentafluoroethyl are preferable. It is preferable that R¹ is methyl because the raw material is easily available, the film hardness after curing is sufficient, and the film has sufficient chemical resistance. Further, it is also preferable that R¹ is phenyl because the solubility of polysiloxane in the solvent is increased and the cured film becomes less likely to crack.

When R¹ is a divalent or trivalent group, R¹ is, for example, preferably (i) a group obtained by removing two or three hydrogen from alkane such as methane, ethane, propane, butane, pentane, hexane, heptane, octane and decane, (ii) a group obtained by removing two or three hydrogen from cycloalkane such as cycloheptane, cyclohexane and cyclooctane, (iii) a group obtained by removing two or three hydrogen from an aromatic compound composed only of a hydrocarbon such as benzene and naphthalene, (iv) a group obtained by removing two or three hydrogen from a nitrogen- and/or oxygen-containing cyclic aliphatic hydrocarbon compound containing an amino group, an imino group and/or a carbonyl group, such as piperidine, pyrrolidine and isocyanurate. It is more preferably (iv), in order to improve pattern sagging and increase adhesion to the substrate.

The number of the repeating units represented by the formula (Ia) is preferably 1% or more, more preferably 20% or more, based on the total number of the repeating units contained in the polysiloxane molecule. Since the high mixing ratio of the repeating unit represented by the formula (Ia) causes deterioration of the electrical characteristics of the cured film, decrease of the adhesion of the cured film to the contact film and decrease of the hardness of the cured film that leads to frequent occurrence of scratches of the film surface. Therefore, the number of the repeating units represented by the formula (Ia) is preferably 95% or less, more preferably 90% or less, based on the total number of the repeating units of the polysiloxane.

The formula (Ib) is as follows:

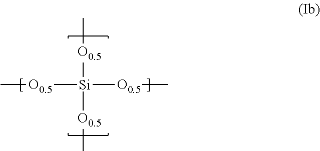

The number of the repeating units represented by the formula (Ib) is preferably 8% or more, more preferably 10 to 99%, further preferably 10 to 80%, based on the total number of the repeating units contained in the polysiloxane molecule. Since the high mixing ratio of the repeating unit represented by the formula (Ib) causes decrease of the compatibility with solvents or additives and increase of the film stress that leads to frequent generation of cracks. The low compounding ratio thereof causes decrease of hardness of the cured film.

The polysiloxane used in the present invention may comprise a repeating unit other than the above, but the number thereof is preferably 20% or less, more preferably 10% or less, based on the total number of the repeating units contained in the polysiloxane molecule. It is also a preferred embodiment of the present invention that it contains no repeating unit other than the above.

The polysiloxane used in the present invention can further comprise a repeating unit represented by the following formula (Ic):

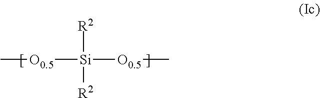

wherein, R² is each independently hydrogen, a mono- to trivalent, linear, branched or cyclic, saturated or unsaturated, C₁₋₃₀ aliphatic hydrocarbon group, or a mono- to trivalent, C₆₋₃₀ aromatic hydrocarbon group, preferably hydrogen, linear, branched or cyclic, C₁₋₆ alkyl, or C₆₋₁₀ aryl, more preferably hydrogen, methyl, ethyl or phenyl, further preferably methyl.

The aliphatic hydrocarbon group and the aromatic hydrocarbon group are each unsubstituted or substituted with fluorine, hydroxy or C₁₋₈ alkoxy,
in the aliphatic hydrocarbon group and the aromatic hydrocarbon group, methylene is not replaced, or one or more methylene are replaced with oxy, imide or carbonyl, provided that R² is neither hydroxy nor alkoxy, and when R² is divalent or trivalent, R² connects each Si contained in a plurality of repeating units.

By having the repeating unit of the formula (Ic), the polysiloxane can be partially formed into a straight-chain structure. However, it is preferable that the straight-chain structural portions are less because the heat resistance is lowered. In particular, the number of the repeating unit of the formula (Ic) is 20% or less, more preferably 10% or less, based on the total number of the repeating units of polysiloxane.

The polysiloxane used in the present invention preferably has silanol at the end. Here, silanol means one in which an OH group is directly bonded to a Si skeleton, and it is one in which hydroxy is directly bonded to a silicon atom in a polysiloxane containing the above-mentioned repeating unit or the like. That is, silanol is formed by binding —O_{0.5}H with —O_{0.5}— of the above formula. The content of silanol in the polysiloxane varies depending on the synthesis conditions of the polysiloxane, for example, the mixing ratio of the monomers and the type of the reaction catalyst. The content of this silanol can be evaluated by quantitative infrared absorption spectrum measurement. The absorption band assigned to silanol (SiOH) appears as an absorption band having a peak in the range of 900±100 cm⁻¹ of the infrared absorption spectrum. The higher the content of silanol, the higher the strength of this absorption band.

When the polysiloxane is measured and analyzed by the FT-IR method (for example, a baseline correction is performed with respect to the FT-IR spectrum of the film obtained by forming a film on a Si wafer using the composition containing a polysiloxane and a solvent and heating at 150° C. for 2 minutes), the ratio S2/S1, that is the ratio of the integrated intensity S2 of an absorption band assigned to SiOH having a peak in the range of 900±100 cm⁻¹ to the integrated intensity S1 of an absorption band assigned to Si—O having a peak in the range of 1,100±100 cm⁻¹ is preferably 0.020 to 0.20, more preferably 0.020 to 0.15.

In addition, the integrated intensity of the absorption band is determined in consideration of noise in the infrared absorption spectrum. In a typical infrared absorption spectrum of polysiloxane, an absorption band assigned to Si—OH having a peak in the range of 900±100 cm⁻¹ and an absorption band assigned to a Si-O having a peak in the range of 1100±100 cm⁻¹ are confirmed. The integrated intensity of these absorption bands can be measured as an area taking account of a baseline for which noise and the like are considered. Incidentally, there is a possibility that the foot of the absorption band assigned to Si—OH and the foot of the absorption band assigned to Si—O are overlapped; however, in such a case, the wavenumber corresponding to the minimal point between the two absorption bands in the spectrum is set as their boundary. The same applies to a case where the foot of the other absorption band overlaps with the foot of the absorption band assigned to Si—OH or Si—O.

The mass average molecular weight of the polysiloxane used in the present invention is preferably 500 to 10,000, more preferably 500 to 6,000 in terms of solubility in an organic solvent, coatability above a substrate, and solubility in an alkaline developer, and further preferably 1,000 to 5,000. Here, the mass average molecular weight is a mass average molecular weight in terms of polystyrene, which can be measured by the gel permeation chromatography based on polystyrene.

The polysiloxane can be used alone or in combination of two or more of any of these. The content of the polysiloxane is preferably 2.0 to 40.0 mass %, more preferably 3.0 to 30.0 mass %, based on the total mass of the polysiloxane composition.

Such a polysiloxane can be obtained by hydrolysis and condensation of, for example, a silicon compound represented by the formula (ia) and/or
a silicon compound represented by the formula (ib), if necessary, in the presence of an acidic catalyst or a basic catalyst:

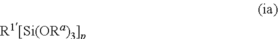

where,
p is an integer of 1 to 3,
R^{1′} is hydrogen, a mono- to trivalent, linear, branched or cyclic, saturated or unsaturated, C₁₋₃₀ aliphatic hydrocarbon group, or a mono- to trivalent, C₆₋₃₀ aromatic hydrocarbon group,
the aliphatic hydrocarbon group and the aromatic hydrocarbon group are each unsubstituted or substituted with fluorine, hydroxy or C₁₋₈ alkoxy,
in the aliphatic hydrocarbon group and the aromatic hydrocarbon group, methylene is not replaced, or one or more methylene are replaced with oxy, imide or carbonyl, provided that R^{1′} is neither hydroxy nor alkoxy, and
R^{a} is C₁₋₁₀ alkyl, preferably methyl, ethyl, n-propyl, isopropyl and n-butyl, and

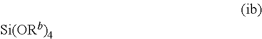

where, R^{b} is C₁₋₁₀ alkyl, preferably methyl, ethyl, n-propyl, isopropyl and n-butyl.

Exemplified embodiments of the silicon compound represented by the general formula (ia) include methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, phenyltrimethoxysilane, phenyltriethoxysilane, trifluoromethyltrimethoxysilane, trifluoromethyltriethoxysilane, 3,3,3-trifluoropropyltrimethoxysilane, tris-(3-trimethoxysilylpropyl)isocyanurate, tris-(3-triethoxysilylpropyl)isocyanurate and tris-(3-trimethoxysilylethyl)isocyanurate, and among them, methyltrimethoxysilane, methyltriethoxysilane, methyltripropoxysilane and phenyltrimethoxysilane are preferred.

Exemplified embodiments of the silicon compound represented by the general formula (ib) include tetramethoxysilane, tetraethoxysilane, tetra-n-propoxysilane, tetra-iso-propoxysilane, tetra-n-butoxysilane, tetra-sec-butoxysilane, tetra-tert-butoxysilane and tetrakis(2-ethylbutoxy) silane, and among them, tetramethoxysilane, tetraethoxysilane and tetra-iso-propoxysilane are preferred.

Here, the silicon compounds can be used in combination of two or more of any of these.

### (II) Ionic Liquid

The composition according to the present invention comprises an ionic liquid.

The ionic liquid is a salt that exists as a liquid in a wide temperature range, and is a liquid consisting only of ions. Generally, a salt having a melting point of 100° C. or lower is defined as an ionic liquid. The ionic liquid used in the present invention has a melting point of 100° C. or lower, preferably 80° C. or lower, more preferably 60° C. or lower, further preferably 30° C. or lower.

The ionic liquid used in the present invention is preferably a basic ionic liquid, preferably one composed of a combination of a strong base and a weak acid.

The cation of the ionic liquid is preferably at least one cation selected from the group consisting of an imidazolium type ion, a pyrrolidinium type ion, a piperidinium type ion, a pyridinium type ion, and an ammonium type ion, and more preferably an imidazolium type ion.

The imidazolium type ion is preferably represented by the following formula (A):

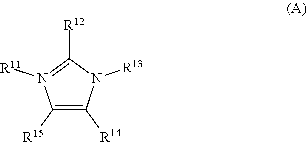

where,
R¹¹, R¹², R¹³, R¹⁴ and R¹⁵ are each independently hydrogen, linear or branched C₁₋₁₈ alkyl, cyclic C₅₋₁₂ alkyl, or C₆₋₁₄ aryl.

Exemplified embodiments of the imidazolium type ion include 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methyl imidazolium, 1-ethyl-3-methylimidazolium, 1-ethyl-2,3-dimethylimidazolium, 2-ethyl-3,4-dimethylimidazolium, 1-propyl imidazolium, 1-propyl-2-methyl imidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethylimidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methyl imidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium, and preferably 1-ethyl-3-methylimidazolium, 1-ethyl-2,3-dimethylimidazolium, 1,3-dimethylimidazolium, 1,2,3-trimethylimidazolium, 1-propyl-3-methylimidazolium, 1-propyl-2,3-dimethylimidazolium, 1-butyl-3-methylimidazolium, 1-butyl-2,3-dimethylimidazolium and 1-octyl-3-methylimidazolium.

The pyrrolidinium type ion is preferably represented by the following formula (B):

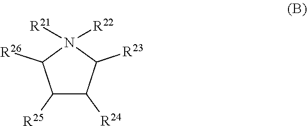

where,
R²¹, R²², R²³, R²⁴, R²⁵ and R²⁶ are each independently hydrogen, linear or branched C₁₋₁₈ alkyl, cyclic C₅₋₁₂ alkyl, or C₆₋₁₄ aryl.

Exemplified embodiments of the pyrrolidinium type ion include 1-methyl-1-ethylpyrrolidinium, 1-methyl-1-propylpyrrolidinium, 1-methyl-1-butylpyrrolidinium, 1-methyl-1-pentylpyrrolidinium, 1-methyl-1-hexylpyrrolidinium and 1-methyl-1-octylpyrrolidinium, and preferably 1-methyl-1-propylpyrrolidinium.

The piperidinium type ion is preferably represented by the following formula (C):

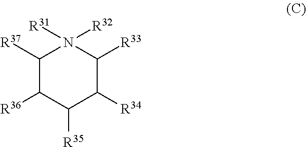

where,
R³¹, R³², R³³, R³⁴, R³⁵, R³⁶ and R³⁷ are each independently hydrogen, linear or branched C₁₋₁₈ alkyl, cyclic C₅₋₁₂ alkyl, or C₆₋₁₄ aryl.

Exemplified embodiments of the piperidinium type ion include 1-methyl-1-ethylpiperidinium, 1-methyl-1-propylpiperidinium, 1-methyl-1-butylpiperidinium, 1-methyl-1-pentylpiperidinium, 1-methyl-1-hexylpiperidinium and 1-methyl-1-octylpiperidinium, and preferably 1-methyl-1-butylpiperidinium.

The pyridinium type ion is preferably represented by the following formula (D):

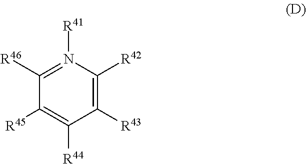

where,
R⁴¹, R⁴², R⁴³, R⁴⁴, R⁴⁵ and R⁴⁶ are each independently hydrogen, linear or branched C₁₋₁₈ alkyl, cyclic C₅₋₁₂ alkyl, or C₆₋₁₄ aryl.

Exemplified embodiments of the pyridinium type ion include 1-methylpyridinium, 1-ethylpyridinium, 1-propylpyridinium, 1-butylpyridinium, 1-pentylpyridinium, 1-hexylpyridinium, 1-octylpyridinium, 1-methyl-3-ethylpyridinium, 1-methyl-4-ethylpyridinium, 1-methyl-3-butylpyridinium, 1-methyl-4-butylpyridinium, 1-ethyl-3-methylpyridinium, 1-ethyl-4-methylpyridinium, 1-propyl-3-methylpyridinium, 1-propyl-4-methylpyridinium, 1-butyl-3-methylpyridinium, 1-butyl-4-methylpyridinium, 1-hexyl-4-methylpyridinium and 1-octyl-4-methylpyridinium, and preferably 1-butylpyridinium and 1-ethyl-4-methylpyridinium.

The ammonium type ion is preferably represented by the following formula (E):

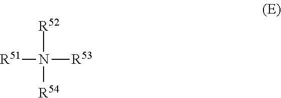

where,
R⁵¹, R⁵², R⁵³ and R⁵⁴ are each independently linear or branched C₁₋₁₈ alkyl, linear or branched C₁₋₁₈ hydroxyalkyl, cyclic C₅₋₁₂ alkyl, or C₆₋₁₄ aryl.

Exemplified embodiments of the ammonium type ion include trimethylethylammonium, trimethylbutylammonium, triethylmethylammonium, tripropylmethylammonium, tributylmethylammonium, trihexylmethylammonium, trioctylmethylammonium, tetrabutylammonium, 2-hydroxyethyltrimethylammonium and tris(2-hydroxyethyl)methylammonium, and preferably tetrabutylammonium, tributylmethylammonium and 2-hydroxyethyltrimethylammonium.

The anion of the ionic liquid is preferably at least one anion selected from the group consisting of a formate ion, an acetate ion, a propionate ion, a lactate ion, an oleate ion, a salicylate ion, a dicyanamide ion, a cyanamide ion, a thiocyanate ion, a methyl sulfate ion, an ethyl sulfate ion, a hydrogen sulfate ion, a methane sulfonate ion, a trifluoromethane sulfonate ion, a p-toluene sulfonate ion, a bis(trifluoromethylsulfonyl)imide ion, a bis(fluorosulfonyl)imide ion, a methyl carbonate ion, a hydrogen carbonate ion, a diethyl phosphate ion, a dibutyl phosphate ion, a hexafluorophosphate ion, a tetrafluoroborate ion, a chlorine ion and a bromine ion, and more preferably an acetate ion, a dicyanamide ion, a cyanamide ion, a chlorine ion and a bromine ion.

In a preferred embodiment, exemplified embodiments of the ionic liquid include trimethylbutylammonium bis(trifluoromethylsulfonyl)imide, tributylmethylammonium dicyanamide, tributylmethylammonium bis(trifluoromethylsulfonyl)imide, tris(2-hydroxyethyl)methylammonium methylsulfate, 2-hydroxyethyltrimethylammonium acetate, 2-hydroxyethyltrimethylammonium lactate, 2-hydroxyethyltrimethylammonium salicylate, tetrabutylammonium chloride, 1,3-dimethylimidazolium methylsulfate, 1,2,3-trimethylimidazolium methylsulfate, 1-ethyl-3-methylimidazolium acetate, 1-ethyl-3-methylimidazolium dicyanamide, 1-ethyl-3-methylimidazolium methylsulfate, 1-ethyl-3-methylimidazolium thiocyanate, 1-ethyl-2,3-dimethylimidazolium bis(trifluoromethylsulfonyl)imide, 1-propyl-3-methylimidazolium acetate, 1-propyl-3-methylimidazolium bis(trifluoromethylsulfonyl)imide, 1-propyl-2,3-dimethylimidazolium bis(trifluoromethylsulfonyl)imide, 1-butyl-3-methylimidazolium acetate, 1-butyl-3-methylimidazolium dicyanamide, 1-butyl-3-methylimidazolium thiocyanate, 1-butyl-3-methylimidazolium bromide, 1-butyl-3-methylimidazolium hexafluorophosphate, 1-butyl-3-methylimidazolium tetrafluoroborate, 1-butyl-2,3-dimethylimidazolium bis(trifluoromethylsulfonyl)imide, 1-octyl-3-methylimidazolium acetate, 1-octyl-3-methylimidazolium bromide, 1-octyl-3-methylimidazolium tetrafluoroborate, 1-methyl-1-butylpyrrolidinium dicyanamide, 1-methyl-1-octylpyrrolidinium bis(trifluoromethylsulfonyl)imide, 1-methyl-1-butylpiperidinium bis(trifluoromethylsulfonyl)imide, 1-ethyl-3-methylpyridinium ethylsulfate, 1-butyl-4-methylpyridinium bis(trifluoromethylsulfonyl)imide and 1-butylpyridinium tetrafluoroborate. In a more preferred embodiment, the ionic liquid has an imidazolium type ion as a cation and an acetate as an anion, and exemplified embodiments thereof include 1-ethyl-3-methylimidazolium acetate, 1-propyl-3-methylimidazolium acetate, 1-butyl-3-methylimidazolium acetate and 1-octyl-3-methylimidazolium acetate.

The ionic liquid has catalytic action that promotes the curing of polysiloxane, and it is assumed that the curing can be completed even at a relatively low temperature.

The mixing ratio of the ionic liquid (II) to the polysiloxane (I) (ionic liquid (II)/polysiloxane (I)) is preferably 0.000030 to 0.10, more preferably 0.000050 to 0.10, further preferably 0.00010 to 0.10, further more preferably 0.0010 to 0.05 in terms of mass ratio. This is because, due to being in such a range, the effect of low temperature curing is more exhibited and the density of the cured film tends to be increased.

Further, since the ionic liquid can be uniformly present in the composition as compared with the commonly used curing accelerator (for example, a thermal base generator), it is assumed that the ionic liquid exhibits effects on suppressing voids.

The ionic liquid can be used alone or in combination of two or more of any of these. The content of the ionic liquid is preferably 0.00020 to 4.0 mass %, more preferably 0.00020 to 3.2 mass %, further preferably 0.0010 to 1.0 mass %, further more preferably 0.010 to 0.50 mass %, based on the total mass of the composition according to the present invention.

### (III) Acid

The composition according to the present invention comprises an acid.

The acid may be an inorganic acid or an organic acid, but is preferably an organic acid, more preferably a carboxylic acid.

Examples of the carboxylic acid include acetic acid, formic acid, propionic acid, butyric acid, valeric acid, acrylic acid, benzoic acid, oxalic acid, maleic acid, fumaric acid, phthalic acid, succinic acid, glutaconic acid, aspartic acid, glutamic acid, malic acid, citraconic acid, acetylenedicarboxylic acid, itaconic acid, mesaconic acid, 3-aminohexanedioic acid, malonic acid, diphenic acid, pyromellitic acid, tricarballylic acid, aconitic acid, hemimellitic acid, trimesic acid, trimellitic acid, mellophanic acid, prehnitic acid, ethylenetracarboxylic acid, 1,2,3,4-butanetetetracarboxylic acid, 1,2,4,5-cyclohexanetetracarboxylic acid, 3,3′,4,4′-biphenyltetracarboxylic acid, 2,3,6,7-naphthalenetetracarboxylic acid, 1,4,5,8-naphthalenetetracarboxylic acid, and mellitic acid, preferably oxalic acid, maleic acid, fumaric acid, phthalic acid, succinic acid, malic acid, citraconic acid, acetylenedicarboxylic acid, malonic acid, benzoic acid, pyromellitic acid, trimellitic acid, or 1,4,5,8-naphthalenetetracarboxylic acid, further preferably maleic acid, phthalic acid, citraconic acid, benzoic acid, pyromellitic acid, trimellitic acid, or 1,4,5,8-naphthalenetetracarboxylic acid.

It is preferable that the acid has high sublimability, which is to sublimate when heated for curing. In particular, the sublimation temperature is preferably 90 to 350° C., more preferably 90 to 250° C. This is because the residual amount of the cured film is reduced by the sublimation of the acid when the film is cured.

Although not wishing to be bound by theory, as described above, the ionic liquid functions as a catalyst that accelerates the curing of polysiloxane at a low temperature. With respect to the composition comprising an ionic liquid, a polysiloxane and a solvent, there is a case that curing is proceeded even during long-term storage at room temperature, resulting in gelation or the like. On the other hand, it is assumed that by combining an acid, it is possible to suppress the catalytic action of the ionic liquid and exhibit good storage stability. It is assumed that the sublimation of the acid during heating for curing makes the catalytic action of the ionic liquid be exhibited and cure at a low temperature.

The acid functions as a pore-generating material. The sublimation of the acid during heating for curing generates fine pores in the cured film. In order to lower the dielectric constant, the acid preferably contains an acid having an aromatic ring. In particular, the component (III) more preferably contains phthalic acid, benzoic acid, pyromellitic acid, trimellitic acid, or 1,4,5,8-naphthalenetetracarboxylic acid.

The mixing ratio of the ionic liquid (II) to the acid (III) ((II)/(III)) is preferably 0.001 to 0.09, and more preferably 0.001 to 0.07, at an equivalent ratio.

The acid can be used alone or in combination of two or more of any of these. The content of the acid is preferably 0.10 to 10.0 mass %, more preferably 0.20 to 9.0 mass %, based on the total mass of the composition according to the present invention. When the content of the acid is in this range, the effect of reducing the dielectric constant is enhanced, and cracks can be effectively suppressed.

### (IV) Solvent

The solvent is not particularly limited as long as it uniformly dissolves or disperses components (I) to (III) and additives added as needed. Examples of the solvent that can be used in the present invention include ethylene glycol monoalkyl ethers such as ethylene glycol monomethyl ether, ethylene glycol monoethyl ether, ethylene glycol monopropyl ether and ethylene glycol monobutyl ether; diethylene glycol dialkyl ethers such as diethylene glycol dimethyl ether, diethylene glycol diethyl ether, diethylene glycol dipropyl ether and diethylene glycol dibutyl ether; ethylene glycol alkyl ether acetates such as methyl cellosolve acetate, ethyl cellosolve acetate; propylene glycol monoalkyl ethers such as propylene glycol monomethyl ether (PGME) and propylene glycol monoethyl ether; propylene glycol alkyl ether acetates such as propylene glycol monomethyl ether acetate (PGMEA), propylene glycol monoethyl ether acetate and propylene glycol monopropyl ether acetate; aromatic hydrocarbons such as benzene, toluene and xylene; ketones such as methyl ethyl ketone, acetone, methyl amyl ketone, methyl isobutyl ketone and cyclohexanone; alcohols such as ethanol, propanol, butanol, hexanol, cyclohexanol, ethylene glycol, glycerin, 3-methoxybutanol and 1,3-butanediol; esters such as ethyl lactate, butyl acetate, 3-methoxybutyl acetate, ethyl 3-ethoxy-propionate and methyl 3-methoxypropionate; and cyclic esters such as γ-butyrolactone, and the solvent is preferably selected from the group consisting of PGMEA, PGME, 3-methoxybutanol, 1,3-butanediol, propylene glycol monomethyl ether acetate, ethyl lactate, butyl acetate, and 3-methoxybutyl acetate. The solvent may be used alone or in combination of two or more of any of these.

So as to make workability improved by the adopted coating method, and in consideration of the permeability of the solution into the fine trenches and the film thickness required outside the trenches, the content of the solvent in the composition according to the present invention can be appropriately selected depending on the mass average molecular weight of the polysiloxane, distribution and structure thereof. The content of the solvent is preferably 50 to 98 mass %, more preferably 60 to 98 mass %, based on the total mass of the composition according to the present invention.

Although the composition according to the present invention essentially includes (I) to (IV), further compounds can be optionally combined. The materials that can be combined are as described below. The total amount of the components other than (I) to (IV) in the entire composition is preferably 10% or less, more preferably 5% or less, further preferably 1% or less, based on the total mass of the composition. It is also an embodiment of the present invention that the composition according to the present invention contains no component other than (I) to (IV).

The composition according to the present invention may optionally comprise other additives. Examples of such additives include a surfactant, an adhesion enhancer, an antifoaming agent, a heat curing accelerator and the like.

The composition according to the present invention can also be used as a composition having photosensitivity by further making a photobase generator, a photoacid generator and the like contained.

### Method for Manufacturing Cured Film

A method for manufacturing a cured film according to the present invention includes applying the composition according to the present invention above a substrate to form a film, and subjecting the film to heating, light irradiation, or a combination thereof. In the present invention, “above a substrate” shall include a case where the composition is directly applied on the substrate and a case where the composition is applied on the substrate via one or more intermediate layers. The method for forming a cured film is described in step order as follows.

(I) Application step

The shape of the substrate is not particularly limited and can be freely selected depending on the purpose. However, the composition according to the present invention is characterized in that it easily penetrates into narrow trenches and the like and can form a uniform cured film even inside the trenches, and therefore can be applied on a substrate with trenches and holes having a high aspect ratio. In particular, it can be applied on a substrate with at least one trench having a width of the deepest portion of 0.2 m or less and an aspect ratio of 2 or more, and the like. Here, the shape of the trench is not particularly limited, and the cross section may be any shape such as a rectangular shape, a forward tapered shape, a reverse tapered shape, and a curved surface shape. Further, both ends of the trench may be open or closed.

As a typical example of a substrate with at least one trench having a high aspect ratio, a substrate for an electronic device comprising a transistor element, a bit line, a capacitor, and the like is referred. In the production of such electronic devices, there is a case that a step of forming an insulating film between a transistor element and a bit line called PMD, between a transistor element and a capacitor, between a bit line and a capacitor or between a capacitor and a metal wiring or an insulating film called IMD between a plurality of metal wirings, or a step of filling isolation trenches is sometimes followed by a through-hole plating step of forming holes penetrating upward and downward through the material for filling a fine trench.

Application can be conducted by any method. It can be freely selected from dip coating, roll coating, bar coating, brush coating, spray coating, doctor coating, flow coating, spin coating, inkjet coating, slit coating, and the like. As the substrate on which the composition is applied, a suitable substrate such as a silicon substrate, a glass substrate, a resin film, and the like can be used. Various semiconductor devices and the like may be formed on these substrates as needed. When the substrate is a film, gravure coating can also be utilized. If desired, a drying step can be additionally provided after film formation. Further, if necessary, the application step can be repeated once, twice, or more to make the film thickness of the film to be formed as desired one.

### (2) Pre-Baking Step

After forming the film by applying the composition, the film can be prebaked (preheating treatment) in order to dry the film and reduce the residual amount of the solvent in the film.

### (3) Curing Step

The film is subjected to heating, light irradiation, or a combination thereof to form a cured film. Here, in the present invention, the cured film means a film having an S2/S1 ratio of less than 0.003.

For heating, a hot plate or an oven can be used. The heating temperature in this curing step is not particularly limited as long as it is the temperature at which the cured film is formed, and it can be freely set. However, if silanol remains, the chemical resistance of the cured film may be insufficient or the dielectric constant of the cured film may be increased. From this point of view, a relatively high heating temperature is generally selected, but when the composition according to the present invention is used, it can be cured at a relatively low temperature. In particular, it is preferable to heat at 500° C. or lower, more preferably 450° C. or lower. On the other hand, in order to promote the curing reaction, the heating temperature is preferably 120° C. or higher, more preferably 140° C. or higher, further preferably 170° C. or higher. Further, the heating time is not particularly limited, and when a hot plate is used, it is preferably 1 to 60 minutes, more preferably 1 to 30 minutes.

The light irradiation is preferably performed at a peak wavelength of irradiation light of 150 to 600 nm, more preferably 200 to 580 nm. Broadband UV light can also be used. One or more lamps can be used as a light source of the irradiation light.

Heating and light irradiation can also be combined.

The curing step is preferably performed in an air atmosphere.

A cured film according to the present invention is manufactured or capable of being manufactured by the above-mentioned method.

The formed cured film is a low dielectric constant siliceous film having dispersion holes. The dielectric constant of the cured film is preferably 2.2 to 2.9, more preferably 2.4 to 2.9. The dielectric constant can be measured using, for example, a mercury probe device manufactured by Semilab Inc.

The film thickness of the cured film to be formed is selected according to the use application, and is preferably 0.10 to 3.0 m, more preferably 0.10 to 2.5 μm.

The cured film according to the present invention can further achieve sufficient transparency, chemical resistance, environmental resistance, heat resistance, and the like. Therefore, it can be suitably used in various fields as an interlayer insulating film for low-temperature polysilicon, a buffer coat film for IC chips, a transparent protective film, and the like.

An electronic device according to the present invention includes the above-mentioned cured film.

The method for manufacturing an electronic device according to the present invention comprises the method for manufacturing a cured film according to the above-mentioned present invention.

The present invention is explained more particularly below with reference to Examples and Comparative Examples, but the present invention is not limited by these Examples and Comparative Examples at all.

Gel permeation chromatography (GPC) is measured using Alliance (trademark) e2695 type high-speed GPC system (Japan Waters K.K.) and Super Multipore HZ—N type GPC column (Tosoh Corporation). The measurement is conducted using monodispersed polystyrene as a standard sample and cyclohexene as a developing solvent, under the measuring conditions of a flow rate of 0.6 ml/min and a column temperature of 40° C., and then mass average molecular weight (hereinafter sometimes referred to as Mw) is calculated as a relative molecular weight to the standard sample.

### Synthesis Example 1: Polysiloxane A

In a 2 L flask equipped with a stirrer, a thermometer and a condenser, 29.1 g of methyltrimethoxysilane, 0.6 g of phenyltrimethoxysilane, 0.4 g of tetramethoxysilane and 308 ml of PGME are charged and the mixture is cooled to 0.2° C. Then, 96.6 g of a 37 mass % tetra-n-butylammonium hydroxide methanol solution is added dropwise to the flask from a dropping funnel, the mixture is stirred for 2 hours. Thereafter, 500 ml of n-propyl acetate is added, and then the mixture is cooled again to 0.2° C. 3 mass % hydrochloric acid aqueous solution of 1.1 equivalence to TBAH is added, and then the mixture is stirred for 1 hour to neutralize. To the neutralized solution, 1,000 ml of n-propyl acetate and 250 ml of water are added, the reaction solution is separated into two layers, and the obtained organic layer is washed 3 times each with 250 cc of water and then concentrated under reduced pressure to remove water and the solvent. Then, PGMEA is added and adjusted to obtain a polysiloxane A solution. The obtained polysiloxane A has a Mw of 2,630 and a S2/S1 of 0.041. In addition, the S2/S1 here is measured using the polysiloxane A solution in the same manner as the method for measuring a S2/S1 described later, except that heating is not performed.

### Synthesis Example 2: Polysiloxane B

In a 2 L flask equipped with a stirrer, a thermometer and a condenser, 32.5 g of a 40 mass % tetra-n-butylammonium hydroxide (TBAH) aqueous solution and 308 ml of 1-methoxy-2-propanol (PGME) are charged. Then, in a dropping funnel, a mixed solution of 19.6 g of methyltrimethoxysilane and 9.4 g of tetramethoxysilane is prepared. The mixed solution is added dropwise into the flask, and the mixture is stirred at room temperature for 2 hours. Thereafter, 500 ml of n-propyl acetate (n-PA) is added, then a 3 mass % maleic acid aqueous solution of 1.1 equivalence to TBAH is added and the mixture is stirred for 1 hour to neutralize. To the neutralized solution, 500 ml of n-propyl acetate (n-PA) and 250 ml of water are added, the reaction solution is separated into two layers, and the obtained organic layer is washed 3 times each with 250 cc of water and then concentrated under reduced pressure to remove water and the solvent. Then, PGME is added and adjusted to obtain a polysiloxane B solution.

The obtained polysiloxane B has a Mw of 2,180 and a S2/S1 of 0.10.

### Method for Measuring S2/S1

The composition containing a polysiloxane and a solvent is dropped on a 4-inch Si wafer, spin-coated at 1,000 rpm, and then heated by a hot plate at 150° C. for 2 minutes to obtain a film. Measurement of the FT-IR spectrum of this film is performed at room temperature using FTIR-6100 (JASCO Corporation). In consideration of noise, a baseline correction is conducted, and the integrated intensity of an absorption band (S2) assigned to Si—OH having a peak in the range of 900±100 cm⁻¹ and the integrated intensity of an absorption band (S1) assigned to Si—O having a peak in the range of 1,100±100 cm⁻¹ are measured, thereby calculating a value of S2/S1. Incidentally, there is a possibility that the foot of the absorption band assigned to Si—OH and the foot of the absorption band assigned to Si—O are overlapped; however, in such a case, the wavenumber corresponding to the minimal point between the two absorption bands in the spectrum is set as their boundary. The same applies to a case where the foot of the other absorption band overlaps with the foot of the absorption band assigned to Si—OH or Si—O.

### Preparation of Polysiloxane Compositions

With the compositions and contents shown in Tables 1 to 3 below, polysiloxane compositions of Examples 101 to 105, 201 to 206 and 301 and Comparative Examples 101 and 201 are prepared. In the tables, the numerical values of the compositions mean mass %.

TABLE 1

| | | | | | | | Comparative |
|---|---|---|---|---|---|---|---|
| | | Example | | | | | Example |
| | | 101 | 102 | 103 | 104 | 105 | 101 |
| Composition | (I) polysiloxane A | 8.00 | 8.00 | 8.00 | 8.00 | 8.00 | 8.00 |
| | (II) ionic liquid A | 0.080 | 0.10 | 0.080 | — | 0.080 | 0.080 |
| | (II) ionic liquid B | — | — | — | 0.040 | — | — |
| | (III) maleic acid | 0.10 | — | 0.11 | — | 0.10 | 0.10 |
| | (III) citraconic acid | — | 0.15 | — | 0.10 | — | — |
| | (III) benzoic acid | — | 1.44 | — | — | — | — |
| | (III) phthalic acid | — | — | 3.90 | — | — | — |
| | (III) pyromellitic acid | 2.45 | — | — | — | — | — |
| | (III) trimellitic acid | — | — | — | 7.00 | — | — |
| | (III) Naph4 | — | — | — | — | 2.93 | — |
| | (IV) PGMEA | Remainder | Remainder | Remainder | Remainder | Remainder | Remainder |
| | Total | 100 | 100 | 100 | 100 | 100 | 100 |
| (II)/(III) equivalent ratio | | 0.012 | 0.023 | 0.010 | 0.002 | 0.012 | 0.273 |
| Evaluation | dielectric constant | 2.66 | 2.63 | 2.50 | 2.72 | 2.89 | 3.00 |
| | withstand voltage (MV/cm) | 5.06 | 4.19 | 4.22 | 4.78 | 4.85 | 5.20 |
| | hardness (GPa) | 0.63 | 0.57 | 0.41 | 0.61 | 0.64 | 0.66 |
| | elastic modulus (GPa) | 10.40 | 9.70 | 6.20 | 11.10 | 10.70 | 13.50 |

TABLE 2

| | | | | | | | | Comparative |
|---|---|---|---|---|---|---|---|---|
| | | Example | | | | | | Example |
| | | 201 | 202 | 203 | 204 | 205 | 206 | 201 |
| Composition | (I) polysiloxane B | 8.00 | 8.00 | 8.00 | 8.00 | 8.00 | 8.00 | 8.00 |
| | (II) ionic liquid A | 0.080 | 0.080 | 0.080 | 0.080 | 0.020 | — | 0.080 |
| | (II) ionic liquid B | — | — | — | — | — | 0.12 | — |
| | (III) maleic acid | 0.10 | 0.10 | 0.10 | — | — | 0.17 | 0.10 |
| | (III) citraconic acid | — | — | — | 0.10 | 0.030 | — | — |
| | (III) benzoic acid | — | — | — | 1.15 | — | — | — |
| | (III) phthalic acid | 3.10 | — | — | — | — | 1.22 | — |
| | (III) pyromellitic acid | — | 2.39 | — | — | 0.50 | — | — |
| | (III) trimellitic acid | — | — | — | — | — | 1.54 | — |
| | (III) Naph4 | — | — | 1.79 | — | — | — | — |
| | (IV) PGME | Remainder | Remainder | Remainder | Remainder | Remainder | Remainder | Remainder |
| | Total | 100 | 100 | 100 | 100 | 100 | 100 | 100 |
| (II)/(III) equivalent ratio | | 0.012 | 0.012 | 0.019 | 0.043 | 0.014 | 0.042 | 0.273 |
| Evaluation | dielectric constant | 2.65 | 2.67 | 2.78 | 2.52 | 2.85 | 2.58 | 3.10 |
| | withstand voltage (MV/cm) | 5.83 | 5.68 | 5.85 | 5.12 | 5.83 | 5.33 | 5.88 |
| | hardness (GPa) | 0.74 | 0.72 | 0.78 | 0.64 | 0.82 | 0.68 | 0.84 |
| | elastic modulus (GPa) | 13.80 | 13.40 | 14.10 | 11.70 | 14.70 | 12.50 | 15.60 |

TABLE 3

| | | Example |
|---|---|---|
| | | 301 |
| Composition | (I) polysiloxane B | 8.00 |
| | (II) ionic liquid A | 0.080 |
| | (II) ionic liquid B | — |
| | (III) maleic acid | 0.10 |
| | (III) citraconic acid | — |
| | (III) benzoic acid | — |
| | (III) phthalic acid | 3.10 |
| | (III) pyromellitic acid | — |
| | (III) trimellitic acid | — |
| | (III) Naph4 | — |
| | (IV) PGME | Remainder |
| | Total | 100 |
| (II)/(III) equivalent ratio | | 0.012 |
| Evaluation | dielectric constant | 2.71 |
| | withstand voltage (MV/cm) | 6.00 |
| | hardness (GPa) | 0.75 |
| | elastic modulus (GPa) | 13.90 |

In the table, ionic liquid A: 1-ethyl-3-methylimidazolium acetate (EMIMAc), ionic liquid B: 2-hydroxyethyltrimethylammonium acetate, Naph4: 1,4,5,8-naphthalenetetracarboxylic acid.

### Manufacturing Cured Film

In the case other than Example 301, the polysiloxane composition is applied on a 4-inch Si wafer using a spin coater (1HDX2, manufactured by Mikasa Co., Ltd.) and prebaked at 130° C. for 120 seconds. Thereafter, heating for curing is performed at 400° C. for 30 minutes to obtain a cured film.

In Example 301, a cured film is obtained in the same manner as described above, except that light irradiation with a high-pressure mercury lamp is performed for 30 minutes after the heating for curing.

The film thickness of each of the obtained cured films is 0.3 m.

### Evaluation of Dielectric Constant and Withstand Voltage

The dielectric constant and withstand voltage of the obtained cured film are measured using a mercury probe device (MCV-530) manufactured by Semilab Inc.

### Evaluation of Hardness and Elastic Modulus

The hardness and elastic modulus of the obtained cured film are measured using an indentation hardness tester ENT-2100 (ELIONIX INC.).

The invention claimed is:

1. A polysiloxane composition comprising:
(I) a polysiloxane,
(II) an ionic liquid,
(III) an acid, and
(IV) a solvent,
wherein the mixing ratio ((II)/(III)) of the ionic liquid (II) to the acid (III) is 0.001 to 0.09 at an equivalent ratio.

2. The composition according to claim 1, wherein
the polysiloxane (I) comprises a repeating unit represented by the following formula (Ia) and a repeating unit represented by the following formula (Ib), and has silanol at an end or side chain, and
the polysiloxane (I) imparts the following characteristics to a film formed therefrom: when a baseline correction is performed with respect to a FT-IR spectrum of such a film that is formed on a Si wafer using the polysiloxane composition followed by heating at 150° C. for 2 minutes, and an integrated intensity S1 of an absorption band assigned to Si—O having a peak in the range of 1,100±100 cm⁻¹ and an integrated intensity S2 of an absorption band assigned to SiOH having a peak in the range of 900±100 cm⁻¹ are measured, the calculated ratio S2/S1 is 0.020 to 0.20,
wherein formula Ia is as follows: 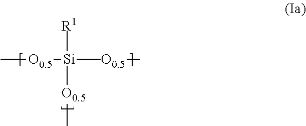
wherein
R¹ is hydrogen, a mono- to trivalent, linear, branched or cyclic, saturated or unsaturated, C₁₋₃₀ aliphatic hydrocarbon group, or a mono- to trivalent, C₆₋₃₀ aromatic hydrocarbon group,
the aliphatic hydrocarbon group and the aromatic hydrocarbon group are each unsubstituted or substituted with fluorine, hydroxy or C₁₋₈ alkoxy;
in the aliphatic hydrocarbon group and the aromatic hydrocarbon group, methylene is not replaced, or one or more methylene are replaced with oxy, imide or carbonyl, provided that R¹ is neither hydroxy nor alkoxy;
when R¹ is divalent or trivalent, R¹ connects Si atoms contained in a plurality of repeating units; and wherein formula Ib is as follows:

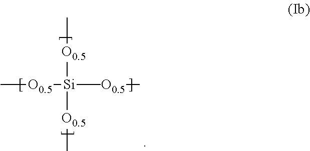

3. The composition according to claim 2, wherein R¹ is hydrogen, a linear, branched or cyclic, C₁₋₆ alkyl, or C₆₋₁₀ aryl.

4. The composition according to claim 1, wherein the cation of the ionic liquid (II) is at least one cation selected from the group consisting of an imidazolium type ion, a pyrrolidinium type ion, a piperidinium type ion, a pyridinium type ion, and an ammonium type ion.

5. The composition according to claim 1, wherein the anion of the ionic liquid (II) is at least one anion selected from the group consisting of a formate ion, an acetate ion, a propionate ion, a lactate ion, an oleate ion, a salicylate ion, a dicyanamide ion, a cyanamide ion, a thiocyanate ion, a methyl sulfate ion, an ethyl sulfate ion, a hydrogen sulfate ion, a methane sulfonate ion, a trifluoromethane sulfonate ion, a p-toluene sulfonate ion, a bis(trifluoromethylsulfonyl)imide ion, a bis(fluorosulfonyl)imide ion, a methyl carbonate ion, a hydrogen carbonate ion, a diethyl phosphate ion, a dibutyl phosphate ion, a hexafluorophosphate ion, a tetrafluoroborate ion, a chlorine ion, and a bromine ion.

6. The composition according to claim 1, wherein the polysiloxane (I) has a mass average molecular weight of 500 to 10,000 as measured by the gel permeation chromatography.

7. The composition according to claim 1, wherein the mixing ratio of the ionic liquid (II) to the polysiloxane (I) ((II)/(I)) is 0.000030 to 0.10 by mass ratio.

8. The composition according to claim 1, wherein the acid is an organic acid.

9. The composition according to claim 1, wherein a ratio of the number of the repeating units represented by the formula (Ib) is 8% or more based on the total number of the repeating units contained in the polysiloxane (I).

10. The composition according to claim 1, wherein the solvent (IV) is at least one selected from the group consisting of propylene glycol monomethyl ether, propylene glycol monoethyl ether, 3-methoxybutanol, 1,3-butanediol, propylene glycol monomethyl ether acetate, ethyl lactate, butyl acetate and 3-methoxybutyl acetate.

11. The composition according to claim 1, wherein the solvent (IV) is included at a concentration of 50 to 98 mass % based on the total mass of the composition.

12. A method for manufacturing a cured film, comprising applying the composition according to claim 1 above a substrate to form a coating film, and subjecting the coating film to heating, light irradiation, or a combination thereof.

13. The method for manufacturing a cured film according to claim 12, wherein the heating is performed at a temperature of 120° C. or higher.

14. The method for manufacturing a cured film according to claim 12, wherein an irradiation light peak wavelength of the light irradiation is 150 to 600 nm.

15. A cured film manufactured by the method according to claim 12.

16. The cured film according to claim 15, which has a dielectric constant of 2.2 to 2.9.

17. An electronic device comprising the cured film according to claim 15.

18. A method for manufacturing an electronic device, comprising the method for manufacturing a cured film according to claim 12.
